(19) United States
(12) Patent Application Publication
(10) Pub. No.: US 2004/0141795 A1
(43) Pub. Date: Jul. 22, 2004

(54) Lead propelling device

(75) Inventors: Takeo Fukumot, Yokohama-shi (JP); Kyo Nakayama, Yokohama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Mitsubishi Pencil Co., Ltd., Tokyo (JP)

(21) Appl. No.: 10/754,723

(22) Filed: Jan. 12, 2004

(30) Foreign Application Priority Data
Jan. 14, 2003 (JP) 2003-005477
Jan. 14, 2003 (JP) 2003-005757

(51) Int. Cl. B43K 21/22

(52) U.S. Cl. 401/92

(57) ABSTRACT

The lead propelling device of the invention is a lead propelling device having a structure for gripping and releasing the lead by a lead gripping mechanism by knocking operation, not transmitting the knocking force to the lead gripping mechanism in knock forward operation, wherein a stopper not allowing the lead to pass by its own weight interlocks with the knock operation, the lead abuts against the stopper rear end upon release of the lead, the lead is inserted into the stopper after gripping the lead in knock backward operation, thereby propelling the lead, and therefore after the knock operation part advances by a predetermined distance, the lead gripping mechanism clears gripping of the lead, and when the lead gripping mechanism grips the lead in the backward stroke of the knock operation part, the knock operation part is set to be movable backward further by a predetermined distance.

### BACKGROUND OF THE INVENTION

1. Field of the Invention

The present invention relates to a lead propelling device capable of projecting a lead by a predetermined length from the leading end of the writing tool by knocking operation, and maintaining the projected lead by the predetermined length if knocking operation is repeated, and more particularly to an improvement of lead propelling device used in mechanical pencil, writing lead holder, or the like.

2. Description of the Related Art

A structure of a hitherto well-known mechanical pencil is shown in FIG. 36, and it is explained according to the drawing.

As shown in FIG. 36, a chuck 125 is provided at a front portion of a shaft tube 123 by way of a shaft joint 124, and a tightening tool 126 is fitted on the outer periphery of gripping part of this chuck 125. A biased chuck spring 128 is provided between a lead case 127 affixed to the rear end of the chuck 125 and the shaft joint 124. By this chuck spring 128, the chuck 125 is tightened by the tightening tool 126, and a lead 129 is gripped.

A slider 131 is fixed at the leading end of a tip 130 attached at the leading end of the shaft tube 123. The slider 131 has a leading end pipe 132 fixed at a front portion of a shaft 131a, and a holding chuck 133 made of rubber or other elastic material fixed at a rear portion, and the lead 129 projects from the leading end pipe 132 by penetrating through the holding chuck 133.

In this state, when the chuck 125 is advanced by pressing (knocking) a knock cover (not shown) fitted to the upper end of the lead case, since the chuck 125 is tightened by the tightening tool 126, it advances while gripping the lead 129.

As a result, the front end of the tightening tool 126 abuts against a step 130a of the tip 130, and when the chuck 125 further advances, tightening by the tightening tool 126 is cleared. Furthermore, if the chuck 125 advances, since the tightening tool 126 is engaged by the step 130a, only the chuck 125 moves forward, and the gripping part at the leading end of the chuck 125 is expanded.

When cleared from the knocked state, while the lead 129 is held in the holding chuck 133 and the gripping part of the chuck 125 is expanded, the chuck 125 retreats. The tightening tool 126 abuts against the shaft joint 124, and when the retreat of the tightening tool 126 is blocked, the chuck 125 begins to grip the lead 129.

At the end of knocking (initial state), the chuck 125 completes gripping of the lead 129.

Thus, in the conventional mechanical pencil, every time the knocking operation is repeated, the front end of the gripping tool 126 abuts against the step 130a to set in a state of expanding the gripping part of the chuck 125, and the front end of the tightening tool 126 abuts against the shaft joint 124 to set in a state of gripping the gripping part of the chuck 125, and that repeating these states, the lead 129 is propelled sequentially.

In such conventional mechanical pencil, since the lead is spent as writing continues, the lead is propelled by knocking occasionally. If forgetting to knock, the lead is worn up to the front end of the leading end pipe 132, and writing may be scratchy, or finally the writing paper may be torn by the front end of the rigid leading end pipe.

On the other hand, if knocked more than necessary to propel the lead, the projected lead may be too long, and the lead is often broken. Or the lead may be projected more than necessary by knocking unknowingly while writing.

As means for solving such problems, Japanese Utility Model Application Laid-open No. S55-99887 discloses a writing lead holder capable of projecting the lead by a specific length from the leading end of the writing tool by knocking operation and maintaining a specific length of a projected lead if the knocking operation is repeated.

This writing lead holder is explained with reference to FIGS. 37 to 40.

As shown in the figures, at the leading end of the shaft tube 151, a taper hole 152 is formed for fitting the chuck 153 for gripping the lead. Inside of the shaft tube 151, there is a tubular lead case 154 for accommodating a lead 155.

An annular protrusion 156 is formed nearly in an intermediate position of the chuck 153. A coil spring 157 is loaded between the annular protrusion 156 and the lead case 154, and the upper end of the chuck 153 is slidably attached in a hole 154a provided in the lower part of the lead case 154. A coil spring 158 is loaded between the annular protrusion 156 and the upper surface of the shaft tube 151 (taper hole 152). The coil spring 158 has a stronger spring than the coil spring 157.

A support arm 159 is affixed to the periphery of the lower part of the lead case 154. A stopper 160 fitting to the leading end of the chuck 153 is formed at the leading end of the support arm 159.

Explaining the operation of the writing lead holder having such structure, first, by removing the cap 161, the writing lead 155 is put into the lead case 154 and chuck 153, and the cap 161 is put on (see FIG. 37). Then, by knocking the cap 161, the lead case 154 compresses the coil spring 157, and moves downward. Along with this move, the support arm 159 also moves downward, and the stopper 160 is departed from the chuck 153 (see FIG. 38). At this time, the upper end of the chuck 153 slides in the hole 154a of the lead case 154.

By further knocking the cap 161, the lead case 154 compresses the coil spring 158, and moves downward. Along with this move, the leading end (gripping part) of the chuck 153 is expanded, and the lead 155 falls by its own weight to the stopper 160 (see FIG. 39).

Later, when knocking of the cap 161 is cleared (released), the chuck 153 and support arm 159 restore the initial state by the repulsive force of the coil springs 157, 158. At this time, the chuck 153 is closed by fitting of the taper hole 152, and the lead 155 is gripped. Since the lead 155 is held by the chuck 153, the lead 155 is projected from the stopper 160 by a predetermined length (see FIG. 40).

When the cap 161 is knocked again, since the lead 155 is held by the chuck 153, only the support arm moves downward, and the state becomes as shown in FIG. 39, and when released from knocking, the state becomes as shown in FIG. 40.

Thus, in this proposed writing lead holder, by knocking operation, the lead can be projected from the leading end of the writing tool by a predetermined length, and the projected lead can be maintained at a predetermined length if knocking operation is repeated.

However, since the coil spring 157 biasing the stopper 160 backward and the coil spring 158 biasing the chuck 153 backward are arranged in series across the annular protrusion 156 of the chuck 153, the projecting length of the lead 155 may not be stable.

For example, if the compression of the coil spring 157 biasing the stopper 160 is advanced to increase the biasing force until becoming equal to the initial biasing force of the spring 158 biasing the chuck 153, the chuck 153 begins to move, and expansion of the chuck 153 starts.

That is, by sliding resistance between members or other factor, the expanding timing of the chuck 153 may be delayed, and the lead projecting extent may not be stable.

Besides, the coil spring 157 biasing the stopper 160 continues to be compressed even after start of expansion of the chuck 153, and the stopper 160 continues to advance. As a result, the distance between the stopper 160 for determining the projection of the lead 155 and the leading end of the chuck 153 continues to increase, and the lead projecting amount may not be stable.

In this action, the relation of the biasing force of the coil springs is expressed as x1<y1, x2=y1, where x1 is the initial biasing force of the coil spring 157 biasing the stopper 160 backward, x2 is the biasing force when the chuck 153 begins to expand, and y1 is the initial biasing force of the coil spring 158 biasing the chuck 153 backward.

The coil spring 158 for biasing the chuck 153 backward is regulated by the rule as mentioned above in relation to the biasing force of the coil spring 157 for biasing the stopper 160 backward (the coil spring 158 is required to have a stronger biasing force), and, for example, if the lead is very fine in a mechanical pencil, the lead may be broken or damaged by the chuck, and it may be bit (broken) and the surface may be roughened (damaged).

In other action, in the case the chuck 153 begins to be expanded when the coil spring 157 biasing the stopper 160 is fully compressed, the overall length of the coil spring 157 when compressed fully may be changed easily due to fluctuations of wire rod diameter, fluctuations of number of turns, or deviation in the radial direction when winding the coil tightly.

In this action, the relation of the biasing force of the coil springs is expressed as X1<Y1 and X2<Y1, where X1 is the initial biasing force of the coil spring 157 biasing the stopper 160 backward, X2 is the biasing force when compressed fully, and Y1 is the initial biasing force of the coil spring 158 biasing the chuck 153 backward.

In this action, too, the coil spring 158 for biasing the chuck 153 backward is regulated by the rule as mentioned above in relation to the biasing force of the coil spring 157 for biasing the stopper 160 backward (the coil spring 158 is required to have a stronger biasing force), and, for example, if the lead is very fine as mentioned above, the lead 155 may be bit by the chuck 153, and the surface may be roughened.

In this writing lead holder, members very difficult to machine are used, which is also a bottleneck for realizing this proposal.

For example, as for the shaft tube 151, aside from forming a taper hole 152 at the leading end, through-holes 151a (see FIG. 38) for pass-through of the support arm 159 of the stopper 160 must be formed at two positions, and this shape is very difficult to process, the productivity is poor, and it is predicted to be a very expensive component.

The support arm 159 requires a very long distance up to the leading end of the lead case 154, and since it is passed in the shaft tube 151, it is predicted that the thickness and width may not be assured sufficiently. The stopper 160 is formed integrally in the support arm 159 but such support arm is very difficult to process, the productivity is poor, and it is predicted to be a very expensive component.

It is also difficult to assemble the writing lead holder. For example, the coil spring 158 biasing the chuck 153 backward is placed between the annular protrusion 156 provided in the center of the chuck 153 and the leading end inner side of the shaft tube 151, but it is impossible to assemble as far as estimated.

Aside from such inconvenience, this proposal seems to project a thick lead as the name of writing lead holder suggests, and this structure is not suited to a mechanical pencil using a fine lead. In a mechanical pencil, for example, since the lead is fine, and in order to prevent lead from breakage, the leading end for projecting the lead and the chuck must be disposed so as not to cause misalignment while maintaining enough rigidity To prevent lead breakage, the projecting length of lead is set to be short, and the leading end of the writing tool must be thinly tapered so that the leading end may be easily visible while writing.

### SUMMARY OF THE INVENTION

The invention is devised to solve the problems of lead breakage and excessive propelling of the lead by knocking unknowingly while writing, and it is hence an object thereof to present a lead propelling device capable of projecting a lead by a predetermined length from the leading end of the writing tool by knocking operation, and maintaining the projected lead by the predetermined length if knocking operation is repeated, and more particularly a lead propelling device stable in lead projecting length, easy to recognize the leading end, easy to use, and free from risk of biting by the gripping part of the chuck even in the case of a fine lead.

The lead propelling device of the invention devised to achieve such object is a lead propelling device having a structure for gripping and releasing the lead by a lead gripping mechanism by knocking operation, not transmitting the knocking force to the lead gripping mechanism in knock forward operation, in which a stopper not allowing the lead to pass by the own weight of the lead interlocks with the knock operation, the lead abuts against the stopper rear end when the lead gripping mechanism releases the lead, the lead is inserted into the stopper after the lead gripping mechanism grips the lead in knock backward operation, thereby propelling the lead, and therefore after the knock operation part advances by a predetermined distance, the lead gripping mechanism clears gripping of the lead, and when the lead gripping mechanism grips the lead in the backward stroke of the knock operation part, the knock operation part is set to be movable backward further by a predetermined distance.

In this manner, in the lead propelling device of the invention, since the timing of gripping and releasing the lead by the lead gripping mechanism is defined by the distance to the parts interlocking with the knock operation, the lead can be projected by a predetermined length, and the projecting length can be stabilized.

The lead propelling device of the invention devised to achieve such object according to another aspect is a lead propelling device for releasing the lead by a lead gripping mechanism by knock operation and gripping the lead by the lead gripping mechanism when the knock operation is cleared, in which a slider is provided so as to project movably forward and backward from the leading end hole at the tip of the leading end of a shaft tube, an elastically dislocating stopper is fixed in the inner hole of the slider for allowing the lead to pass and blocking pass-through of the lead by abutting against the leading end of the lead at equal to or below a predetermined pressing force, the slider is biased backward by a spring so as to interlock with a lead case, a lead gripping mechanism is provided behind the slider, the lead gripping mechanism is composed so as to grip or release the lead by departing or abutting between a step of the rear part of the lead gripping mechanism and a step of the lead case, the lead gripping mechanism holds the lead until the knock operation part advances by a predetermined distance, maintaining a fixed state, the slider advances in conjunction with the lead case, and the front end of the lead is departed from the rear end of the stopper by a predetermined distance, and when the knock operation part is further advanced from the predetermined distance, the slider and chuck advance in conjunction with the lead case, and the lead gripping mechanism releases gripping of the lead, the lead abuts against the stopper rear end by spontaneous fall of the lead, when the knock operation part moves backward by clearing the knock operation, the slider and chuck retreat, and when the lead gripping mechanism grips the lead, only the slider moves backward to the initial position and the lead passes through the stopper, so that the lead is projected from the leading end of the slider by a predetermined length.

Thus, the lead propelling device of the invention has a structure for gripping and releasing the lead by the lead gripping mechanism for allowing departing and abutting between the step of the lead gripping mechanism rear part and the step of the lead case, and the timing of gripping and releasing the lead by the lead gripping mechanism is determined by the spatial distance of the action part of the lead gripping mechanism rear part and the action part of the lead case.

Therefore, the lead projecting length is stable. If the lead is fine, rigidity is maintained between the slider for projecting the lead and the lead gripping mechanism, and misalignment is prevented. Besides, in order that the leading end may be easily recognized visually while writing, the leading end of the writing tool is tapered and thin.

According to an another aspect, the lead propelling device of the invention devised to achieve such object is a lead propelling device for releasing the lead by a lead gripping mechanism by knock operation and gripping the lead by the lead gripping mechanism when the knock operation is canceled, in which a slider is provided so as to project movably forward and backward from the leading end hole at the tip of the leading end of a shaft tube, an elastically dislocating stopper is fixed in the inner hole of the slider for allowing the lead to pass and blocking pass-through of the lead by abutting against the leading end of the lead at equal to or below a predetermined pressing force, the slider is biased backward by a spring so as to interlock with a lead case by way of a link unit, a lead gripping mechanism is provided at a rear portion of the slider in a state of gripping the lead, the lead gripping mechanism maintains the lead gripping state when knock operation is started, the slider advances in conjunction with the lead case by way of the link unit, the lead is departed from the stopper rear end by a predetermined distance when the slider advances to the maximum and the advance is blocked, and when the knock operation further continues, the link unit contracts and the lead case advances, thereby releasing the lead by the lead gripping mechanism, the lead abuts against the stopper rear end by spontaneous fall of the lead, when knock operation is canceled, the lead gripping mechanism grips the lead while the slider maintains the foremost position, and the slider retreats to the initial position, and the lead passes through the stopper, so that the lead is projected from the leading end of the slider by a predetermined length.

Even if this lead propelling device, the lead can be projected by a predetermined length, and the projection length can be stable.

### BRIEF DESCRIPTION OF THE DRAWINGS

FIG. 1 is a general longitudinal sectional view of initial state of mechanical pencil in a first embodiment of the invention;

FIG. 2 is a perspective view showing components of FIG. 1;

FIG. 3 is a perspective view showing development of components of a lead gripping mechanism;

FIG. 4 is a perspective view of an assembled lead gripping mechanism;

FIG. 5 is a perspective view showing development of components of a slider;

FIG. 6 is a perspective view of an assembled slider;

FIG. 7 is a sectional view of lead gripping mechanism;

FIG. 8 is an explanatory view of working state of mechanical pencil in the first embodiment, being a sectional view showing writing state;

FIG. 9 is an explanatory view of working state of mechanical pencil in the first embodiment, being a sectional view showing knocking initial state of stopper clearing lead gripping;

FIG. 10 is an explanatory view of working state of mechanical pencil in the first embodiment, being a sectional view showing full knocking state of chuck releasing the lead;

FIG. 11 is an explanatory view of working state of mechanical pencil in the first embodiment, being a sectional view showing state of lead gripped again by chuck after retreat of lead case;

FIG. 12 is an explanatory view of working state of mechanical pencil in the first embodiment, being a sectional view showing state of projection of leading end of lead by a proper length from the front end of a tip member after retreat of lead case to initial state;

FIG. 13 is a perspective view showing a modified example of slider;

FIG. 14 is a perspective view of stopper used in the slider shown in FIG. 13;

FIG. 15 is a perspective view showing a modified example of slider;

FIG. 16 is a perspective view of stopper used in the slider shown in FIG. 15;

FIG. 17 is a general longitudinal sectional perspective view of a lead propelling device in a second embodiment of the invention;

FIG. 18 is a perspective view showing component unit, components, and others of lead propelling device in the second embodiment;

FIG. 19 is a perspective view showing development of components of lead gripping mechanism;

FIG. 20 is a perspective view of assembled lead gripping mechanism;

FIG. 21 is a perspective view showing development of components of link unit;

FIG. 22 is a perspective view of assembled link unit;

FIG. 23 is a perspective view showing development of components of slider;

FIG. 24 is a perspective view of assembled slider;

FIG. 25 is an explanatory view of working state of the lead propelling device in the second embodiment, being a sectional view showing slightly projecting state of lead to the leading end of tip member of slider;

FIG. 26 is a sectional view corresponding to FIG. 25, in section B-B direction in FIG. 27;

FIG. 27 is a section A-A view in FIG. 25;

FIG. 28 is a sectional view showing a state of front side of slider flange abutting against the inner step behind the tip by knocking the rear end to advance the lead case;

FIG. 29 is a sectional view corresponding to FIG. 28;

FIG. 30 is a sectional view showing a state of release of lead gripping by the chuck by advancing link and chuck joint by further advancing the lead case in blocked state of advance of slider;

FIG. 31 is a sectional view corresponding to FIG. 30;

FIG. 32 is a sectional view showing a state of lead gripped again by the chuck by retreat of lead case and retreat of link and chuck joint with the slider held in the foremost position;

FIG. 33 is a sectional view corresponding to FIG. 32;

FIG. 34 shows a state of leading end of lead projected by a proper length from front end of tip member after retreat of lead case to initial state and the interval between front end of slider flange and the inner step behind the tip becomes P again;

FIG. 35 is a sectional view corresponding to FIG. 34;

FIG. 36 is a sectional view of general lead propelling device in a conventional mechanical pencil;

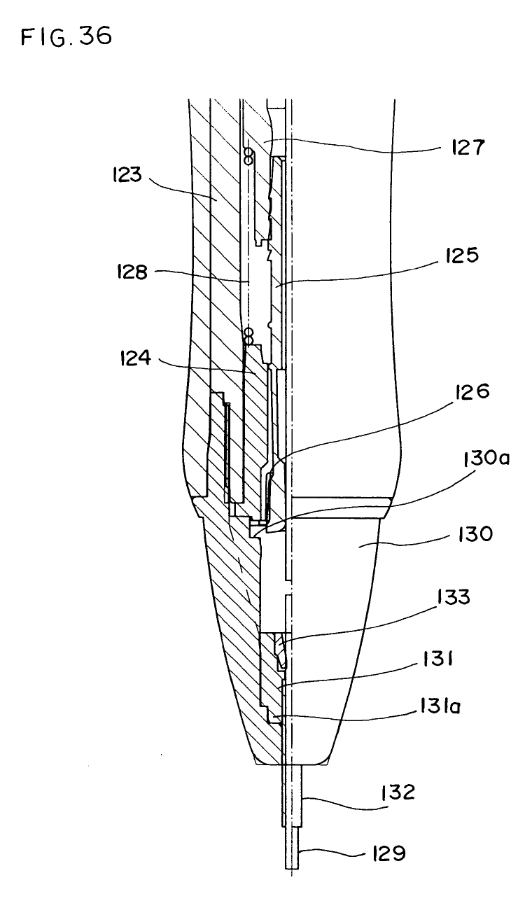

FIG. 37 is a sectional view of writing lead holder proposed in Japanese Utility Model Application Laid-open No. S55-99887;

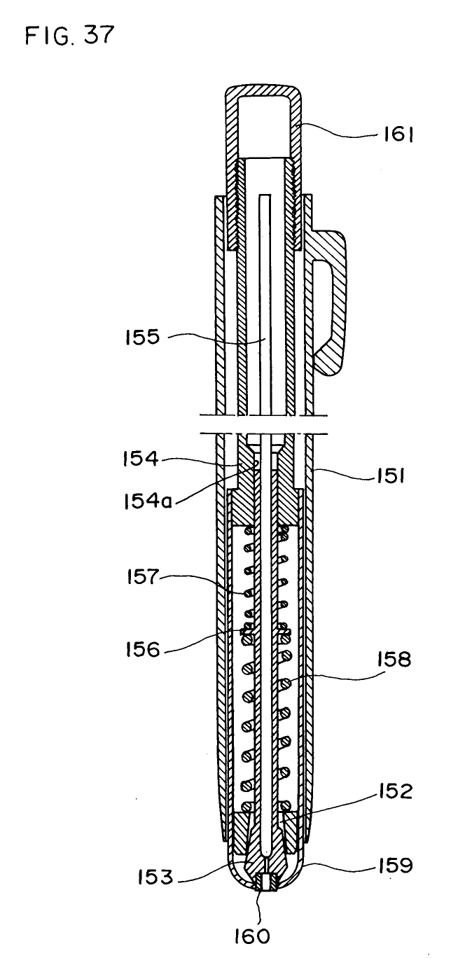

FIG. 38 is a sectional view showing working state of writing lead holder shown in FIG. 37; and

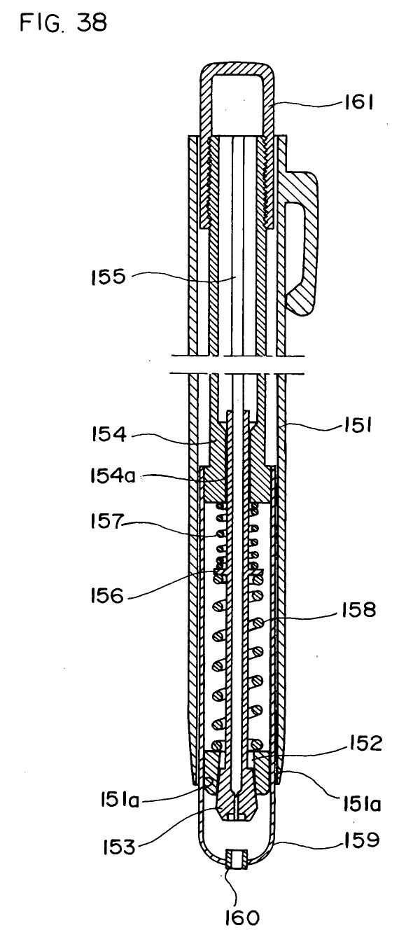

FIG. 39 is a sectional view showing working state of writing lead holder shown in FIG. 37; and

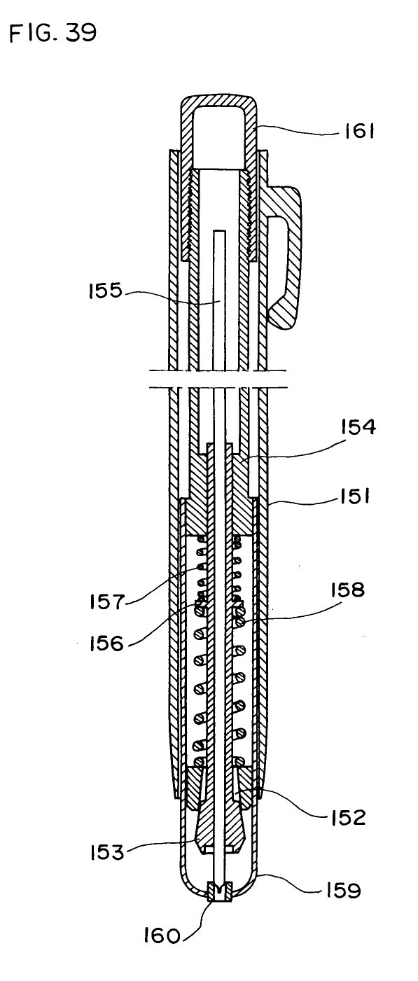

FIG. 40 is a sectional view showing working state of writing lead holder shown in FIG. 37.

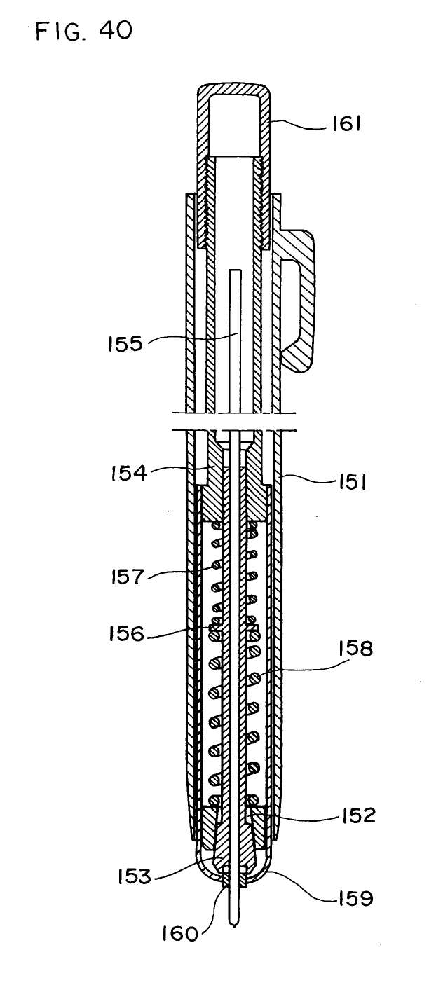

### DESCRIPTION OF THE PREFERRED EMBODIMENTS

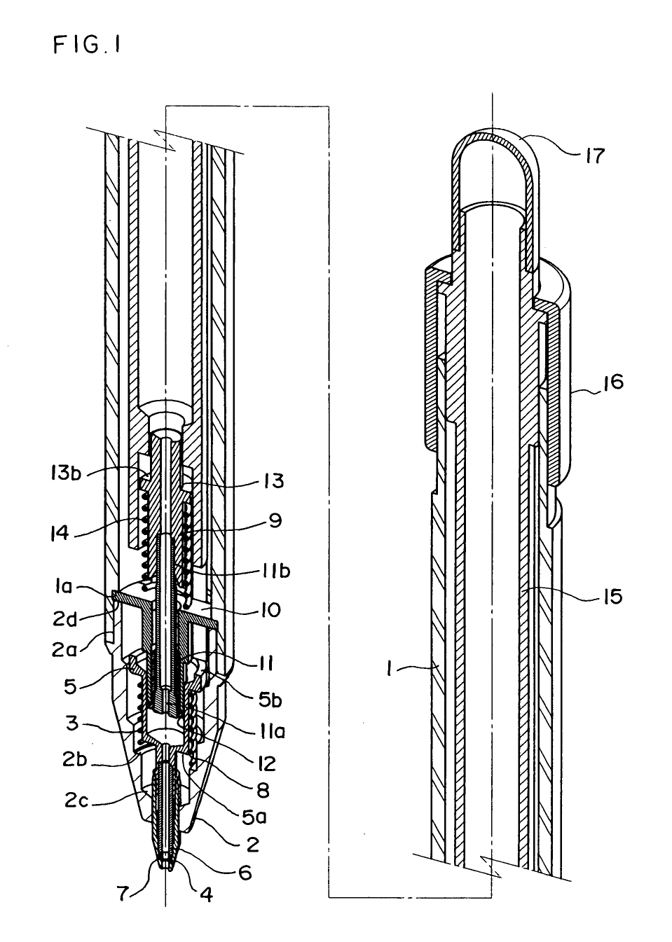

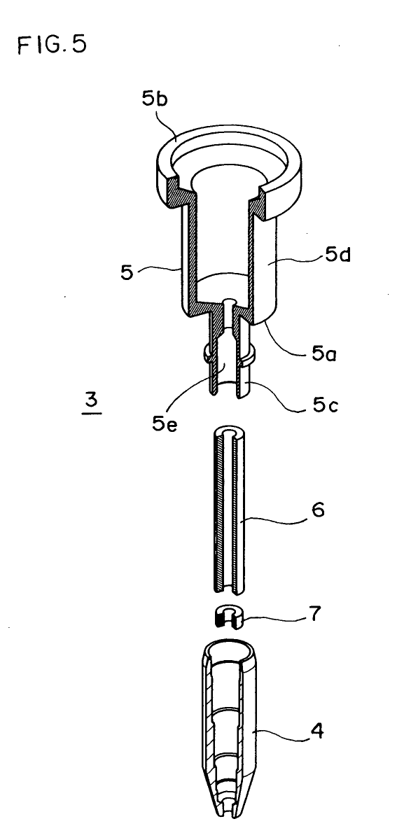

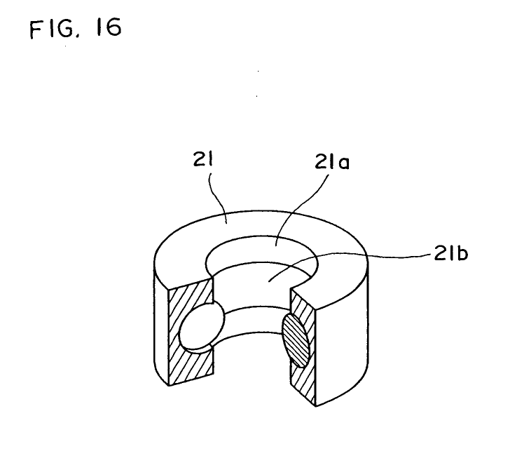

Embodiments are described below with reference to the accompanying drawings. FIGS. 1 to 16 show a lead propelling device in a first embodiment of the invention.

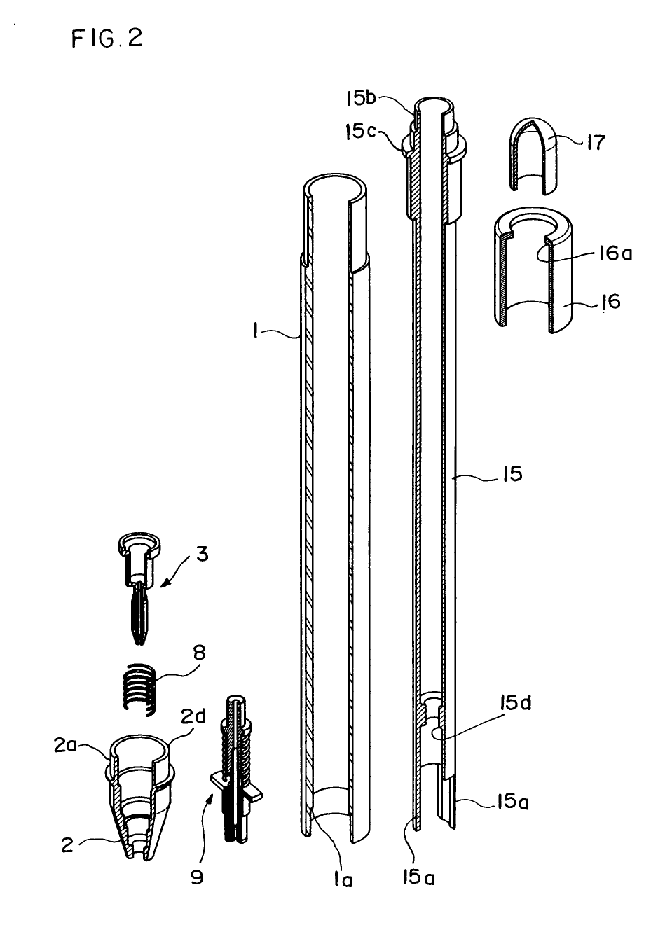

A mechanical pencil in the first embodiment comprises, as shown in FIGS. 1 and 2, a shaft tube 1, a tip 2, a slider 3, a lead gripping mechanism 9, a lead case 15, a knock cover 17, other components and component units. The configuration of the first embodiment is explained below, first relating to the component units of the lead gripping mechanism 9 and slider 3.

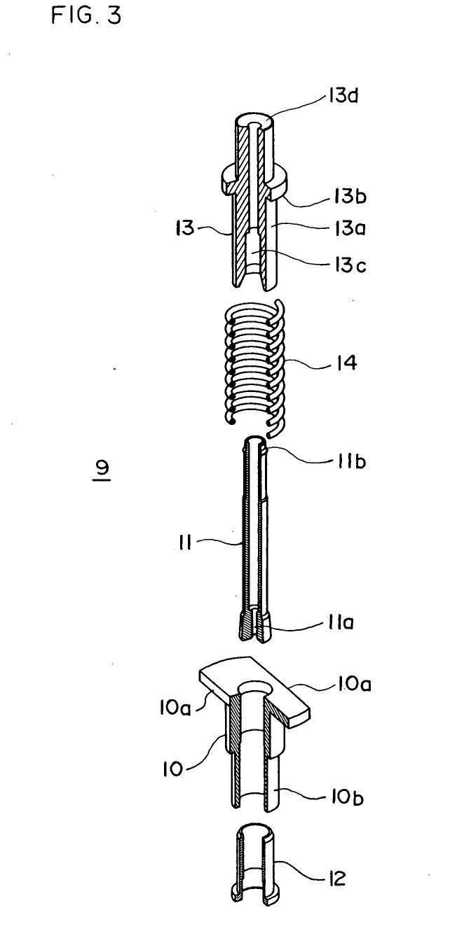

The lead gripping mechanism 9 is explained. As shown in FIG. 3, the lead gripping mechanism 9 includes a fixing tube 10, a chuck 11, a chuck spring 14, and a chuck joint 13.

The fixing tube 10 has a guide surface 10a of cylindrical shape of which both sides are cropped flatly, and a fine end tube 10b is formed at the front end. A tightening ring 12 is press-fitted and fixed as tightening part in the inner hole of the end tube 10b.

The tightening ring 12 is made of thin metal tubular body in a design to form a slender writing tool on the whole, but it is not always required in the structure of the invention, and it may be integrally formed as tightening part in the inner hole of the end tube 10b.

The chuck 11 is same as a chuck used generally in a mechanical pencil, and two-division or three-division slits are formed in the outer circumference of the gripping part 11a, and it is formed freely to expand and contract, and a convex engaging portion 11b is formed at the rear end of the chuck 11.

The chuck spring 14 is attached to a shaft 13a of the chuck joint 13, and the rear end of the chuck spring 14 abuts against the step 13b, and the front end abuts against the rear end of the fixing tube 10. In this state, the tightening ring 12 is inserted in the chuck 11, and the chuck 11 is inserted from the front end of the fixing tube 10.

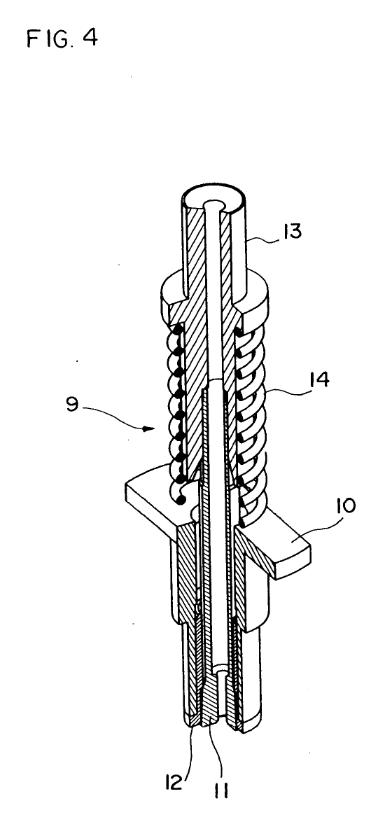

The engaging portion 11b of the chuck 11 is press-fitted and engaged in a engaging hole 13c at the front end of the shaft 13a of the chuck joint 13, and the lead gripping mechanism 9 as shown in FIG. 4 is composed.

The slider 3 is explained with reference to FIGS. 1, 2, 5, and 6.

This slider 3 has a fine tip member 4, a stopper 7, a guide pipe 6, and a rear member 5.

Nearly at the front end of the inner hole of the tip member 4, an elastic stopper 7 is inserted. In the inner hole of the tip member 4, the front part of the guide pipe 6 is fixed so as to arrest the rear end of the stopper 7.

Further, the rear member 5 has a small diameter portion 5c and a large diameter portion 5d, and the small diameter portion 5c and large diameter portion 5d are separated by a step 5a. A hole 5e is formed in the small diameter portion 5c, and a circular flange 5b is formed behind the large diameter portion 5d.

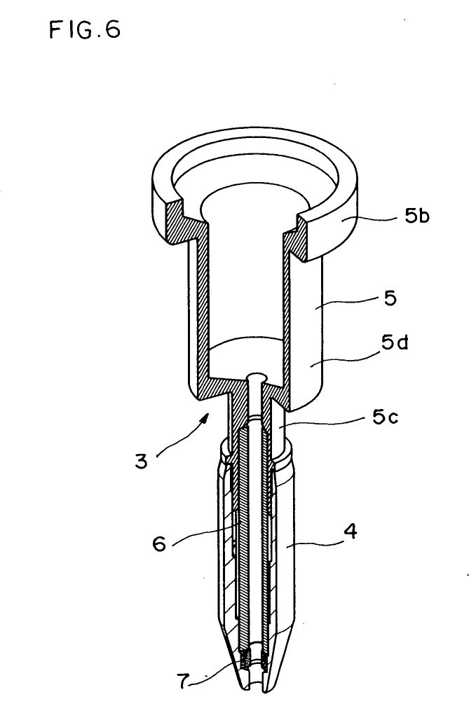

The rear part of the guide pipe 6 is fixed in the hole 5e, and the front end of the small diameter portion 5c of the rear member 5 is fixed to the rear end hole of the tip member 4, and the slider 3 as shown in FIG. 6 is composed.

The slider 3 allows the lead to pass by way of the inner hole of the guide pipe 6 and inner hole of the stopper 7, and the leading end of the lead abuts against the rear end of the stopper 7 at equal to or below a predetermined pressure, so that the lead may not be passed in. The stopper 7 is made of elastically dislocating material such as rubber.

The entire structure of the invention is explained with reference to FIGS. 1 to 7, and 13 to 16.

In the lead propelling device in the first embodiment, as shown in FIG. 2, a circular protrusion or circular step 1a is formed in the front inner wall of the inner hole of the shaft tube 1.

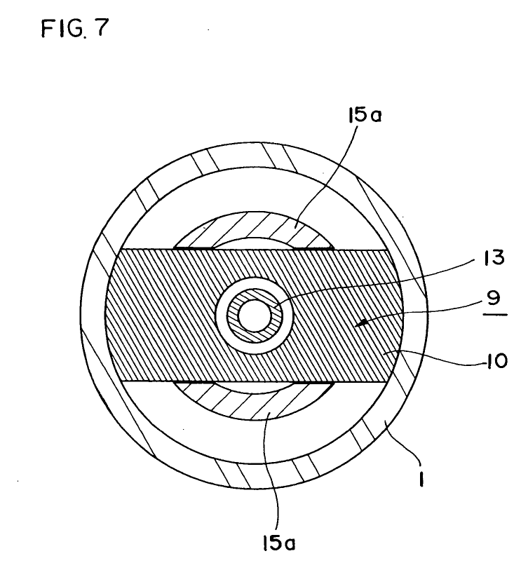

The lead gripping mechanism 9 is inserted from the front side of the shaft tube 1, and the rear end of the fixing tube 10 is abutted against and fixed to the front part of the step 1a. In succession, from behind the shaft tube 1, the lead case 15 is inserted. A pair of opposing legs 15a are formed in the front part of the lead case 15. By inserting the lead case 15, the inner side of the leg 15a of the lead case 15 is set opposite to the flat guide surface 10a of the fixing tube 10 (see FIG. 7).

The lead case 15 is a long tubular body as shown in FIG. 2, having a shaft 15b for detachably fixing the knock cover 17 at its rear end, and a flange 15c is formed slightly ahead. A step 15d is provided at the rear end of the lead case leg 15a, and this step 15d actuates the chuck joint 13 of the lead gripping mechanism 9 by knocking operation.

With the lead case 15 inserted from behind the shaft tube 1, a crown 16 is attached on the rear end outer periphery of the shaft tube 1.

As shown in FIGS. 1 and 2, the spring 8 is fitted with its rear end abutting against the front side of the step 5a of the rear member 5 of the slider 3, the front end of the spring 8 is abutted against the step provided in the inner hole of the tip 2, and the slider 3 is inserted into the inner hole of the tip 2. A threaded part of the shaft 2a of the tip 2 is engaged with the threaded part of the shaft tube 1, and the fixing tube 10 is fixed between the rear end 2d of the shaft 2a and the step 1a of the shaft tube 1.

At this time, the rear end of the flange 5b of the slider 3 is in contact with the leg 15a at the front end of the lead case 15. As mentioned above, since the crown 16 is attached on the rear end outer periphery of the shaft tube 1, the inner step 16a at the rear end of the crown 16 abuts against the rear end of the flange 15c of the lead case 15, and the lead case 15 is pressed forward.

A knock cover 17 is detachably fitted to the outer periphery of the shaft 15b provided at the rear end of the lead case 15.

The fixing tube 10 of the embodiment has a guide surface 10a having both sides of cylindrical shape cropped flatly, and the inner side of the leg 15a of the lead case 15 is inserted and guided oppositely to the flat guide surface 10a of the fixing tube 10, but this guide format may be changed or modified depending on the design.

When the lead case 15 is twisted by force in the rotating direction, to prevent deformation or breakage of the legs 15a due to distortion, the lead case 15 may be provided with a rotation stopper. The format of the rotation stopper may be varied depending on the design, and when rotation of the lead case 15 on the shaft tube 1 is prevented, the rotation can be prevented without increasing the number of components.

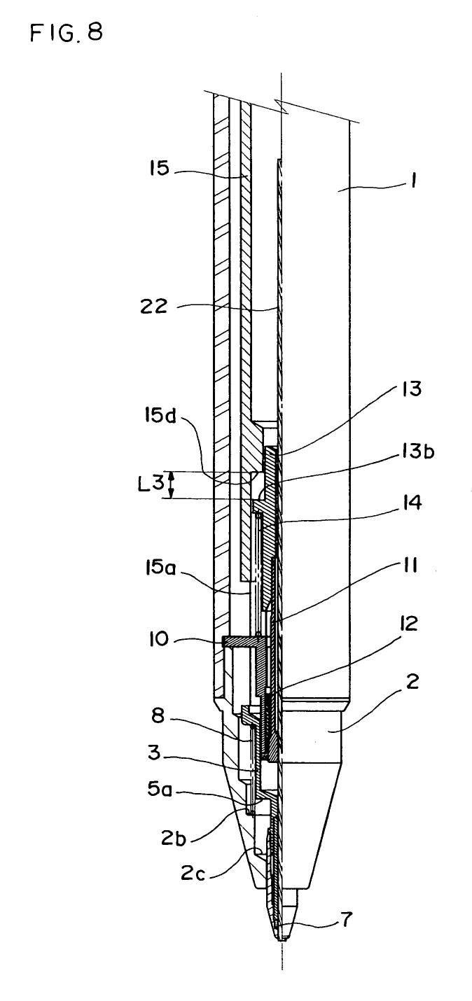

As mentioned above, the crown 16 is provided on the rear end outer periphery of the shaft tube 1, and when the crown 16 is provided on the shaft tube 1 so as to allow rotation or move, the lead case 15 can be moved forward and backward. Then, by this move of this lead case 15, as shown in FIG. 8, the interval L3 of the step 15d of the lead case and step 13b of the chuck joint can be expanded or contracted. That is, it can be used as an adjusting device of interval L3.

In this case, the adjusting device generally has a spiral structure, but the mechanism is not limited to this example alone. Moreover, to prevent deviation of adjustment position, a lock mechanism maybe provided, or a display may be provided so that the level of adjustment may be known. Or the crown 16 may be fixed in a state of keeping the interval L3 at an appropriate value.

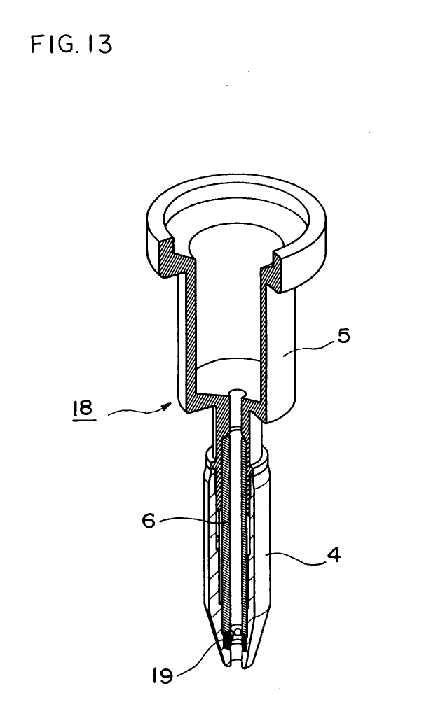

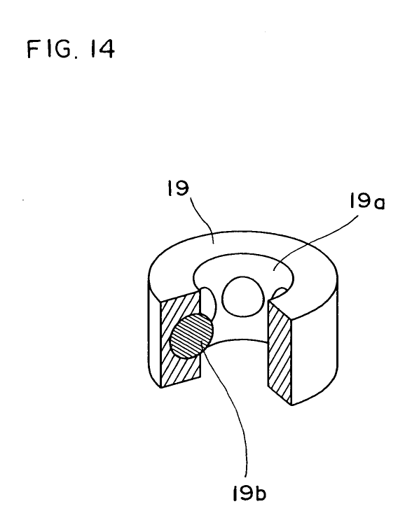

Referring now to FIG. 13, a slider 18 is explained as a modified example of the slider 3. This slider 18 is basically same in structure as the slider 3, and differs only in the composition of a stopper 19. As shown in FIG. 14, the stopper 19 has a plurality of hard parts 19b provided in the inner hole circumference of the elastic part 19a.

Accordingly, with the leading end of the lead abutting against the hard parts, and a predetermined pressing force applied to the leading end of the lead, the lead can be passed through. For example, the elastic part 19a is formed of rubber or similar material, and the hard part 19b is made of spherical or irregular metal or nonmetallic particle.

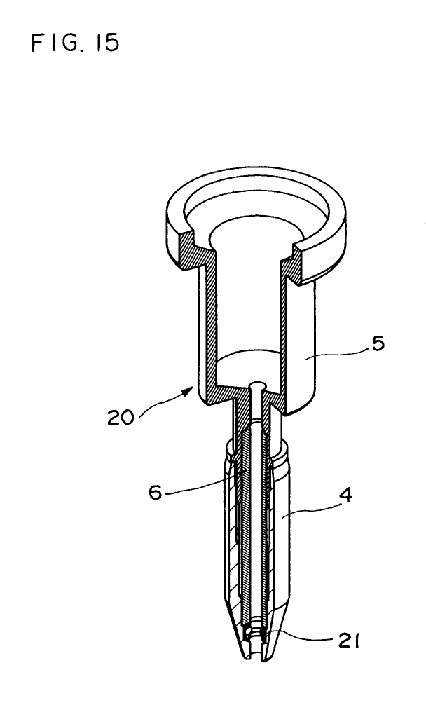

With reference to FIG. 15, a slider 20 is explained as a modified example of the slider 3. The slider 20 also differs in the structure of a stopper 21 only. The stopper 21 has a ring-shaped hard part 21b provided in the inner hole periphery of the elastic part 21a. Accordingly, with the leading end of the lead abutting against the hard part 21b, and a appropriate pressing force applied to the leading end of the lead, the lead can pass through. The hard part 21b of the stopper 21 is made of metal or nonmetallic C-ring, and is fixed in the concave groove of the inner hole of the elastic body 21a.

The stopper is not particularly specified in structure as far as it is made of spring material of metal or nonmetallic material and the lead can pass through with a predetermined pressure applied to the leading end of the lead.

The mechanical pencil of the embodiment is thus configured, but is not particularly specified in the format of the component units and components. For example, the slider 3 is composed of multiple components, but it can be also made of a single element in an extreme case. A leg may be provided in the rear part of the slider, and the leg rear end face and the lead case front end face may contact with each other. Alternatively, by the spring 8 provided between the tip 2 and the slider 3, the lead case 15 is biased backward together with the slider 3, but the spring 8 can be also provided behind the shaft tube 1. By coupling and fixing the slider and lead case, the lead case may be biased backward by the spring.

Best modes may be set depending on the design.

Referring to FIGS. 8 to 12, the operation of the lead propelling device of the first embodiment is explained.

FIG. 8 shows an initial state before knocking operation in writing state. In this state, the chuck 11 is biased backward by the chuck spring 14, and the lead 22 is gripped, and the lead case 15 and slider 3 are integrally pushed backward by the spring 8. Here, the strength of the spring 8 and chuck spring 14 can be set independently. Therefore, the strength of the chuck spring 14 can be set to a proper strength for gripping the lead.

In this state, as mentioned above, the lead 22 is gripped by the chuck 11, and projected from the slider 3, and it is ready to write.

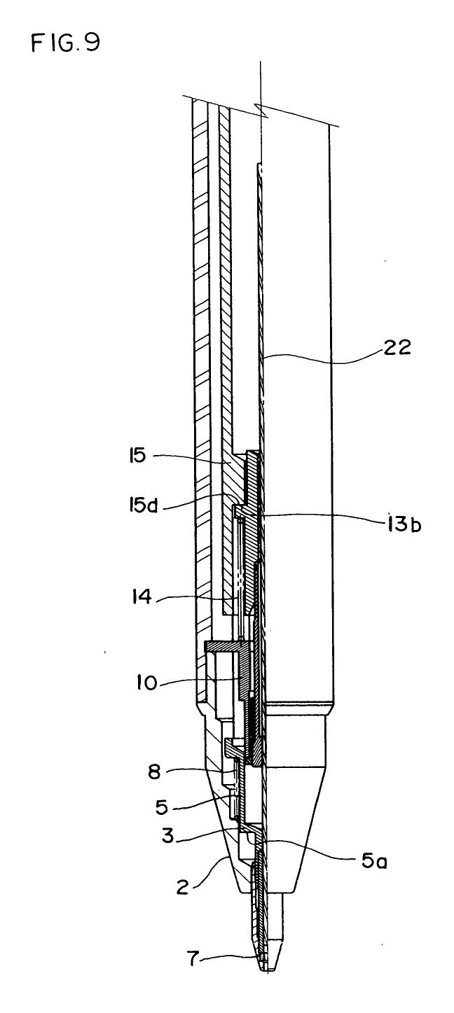

When the lead is worn out in writing state in FIG. 8, the rear end (knock cover 17) of the lead case 15 is knocked. An initial state upon start of knocking (the state of moving the lead case 15 by distance L3) is shown in FIG. 9.

When knocking starts, the lead case 15, integrally with the slider 3, begins to compress the spring 8. As shown in FIGS. 8 and 9, when the spring 8 is compressed by the distance L3 between the lead case step 15d and the chuck joint step 13b, the lead case step 15d abuts against the chuck joint step 13b.

At this time, the lead 22 is fixed in a state being gripped by the chuck 11, and the tip 4 of the slider 3 moves forward, and the stopper 7 goes through at a front portion of the lead 22.

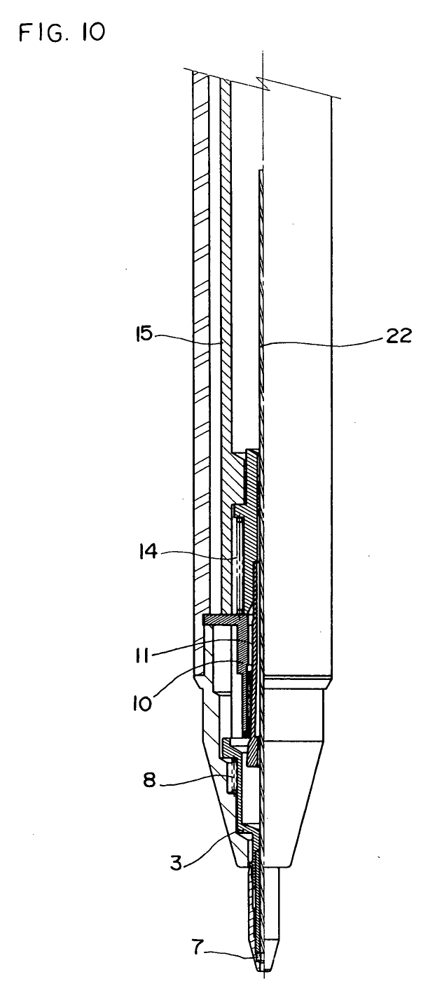

When further knocked from the state in FIG. 9, since the slider 3 and lead case 15 are in interlock, while continuing compression of the spring 8, compression of the chuck spring 14 begins. In this state, the chuck 11 also begins to move forward, and gripping of the lead 22 is released, and the step 5a of the rear member 5 abuts against the tip step 2c to be set in full knocking state. In the full knocking state, the lead 22 is released from the chuck 11 and stopper 7, and the lead falls spontaneously by the own weight of the lead, and abuts against the rear end of the stopper 7. FIG. 10 shows a full knocking state of releasing the lead 22.

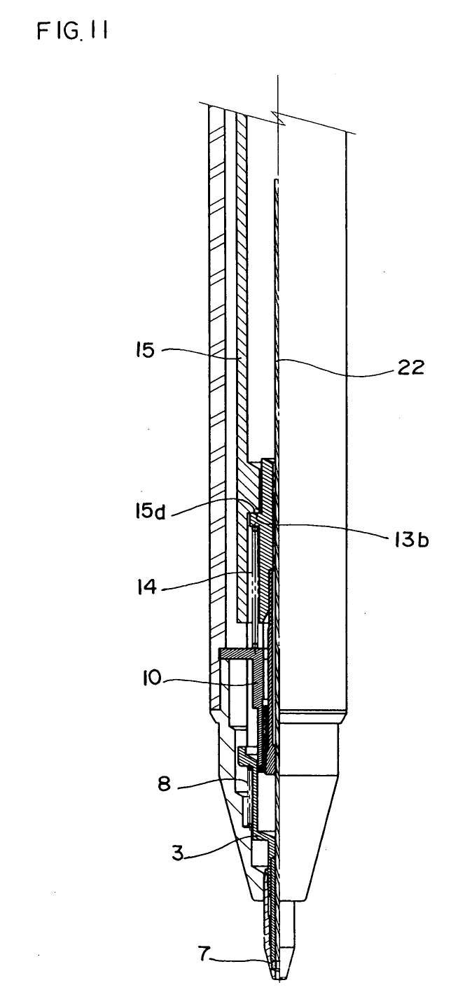

When knocking is released from full knocking state, the lead 22, slider 3, lead case 15, and chuck 11 begin to move backward all together. The chuck 11 is pulled to the tightening ring 12 of the fixing tube 10 by the chuck spring 14, and gripping of the lead 22 is complete (see FIG. 11).

When further released from knocking, the chuck 11 stops moving backward by means of the fixing tube 10, and maintains the lead gripping state. On the other hand, the lead case 15 and slider 3 continue to move backward. At this time, the lead case step 15d returns to the initial state to the distance L3 to the chuck joint step 13b.

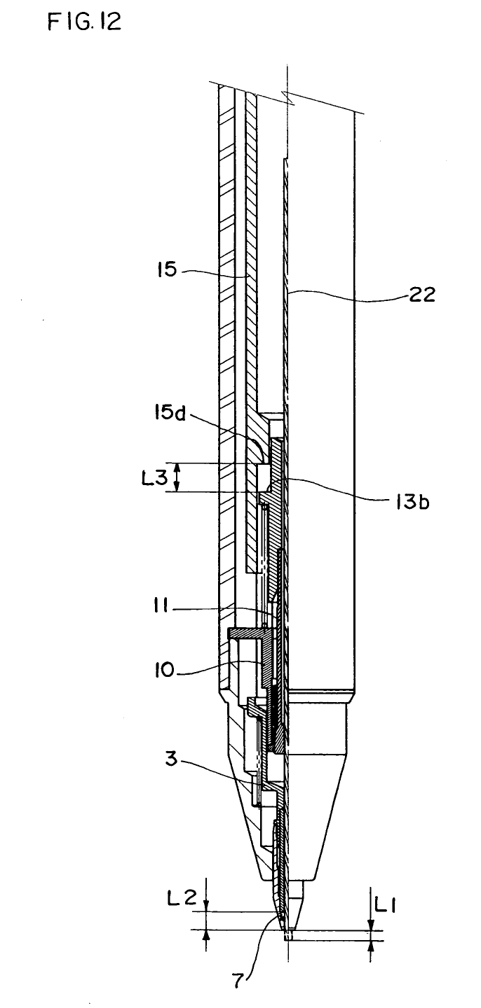

The lead 22 gripped by the chuck 11 penetrates through the stopper 7 as the slider 3 and lead case 15 further move backward, and projects from the leading end of the slider 3 by distance L1 (see FIG. 12). That is, L1=L3−L2.

In this state, if knocked again, as the lead case 15 moves by distance L3, as shown in FIG. 9, the stopper 7 goes through at a front portion of the lead 22. As a result, the state as shown in FIGS. 10 to 12 is established.

Thus, even if the knocking operation is repeated, by repeating the motion shown in FIGS. 9 to 12, the lead 22 projects from the slider 3 only by the specified extent. If the lead 22 is worn out by writing, by this operation, the lead can be projected from the slider 3 by the predetermined length.

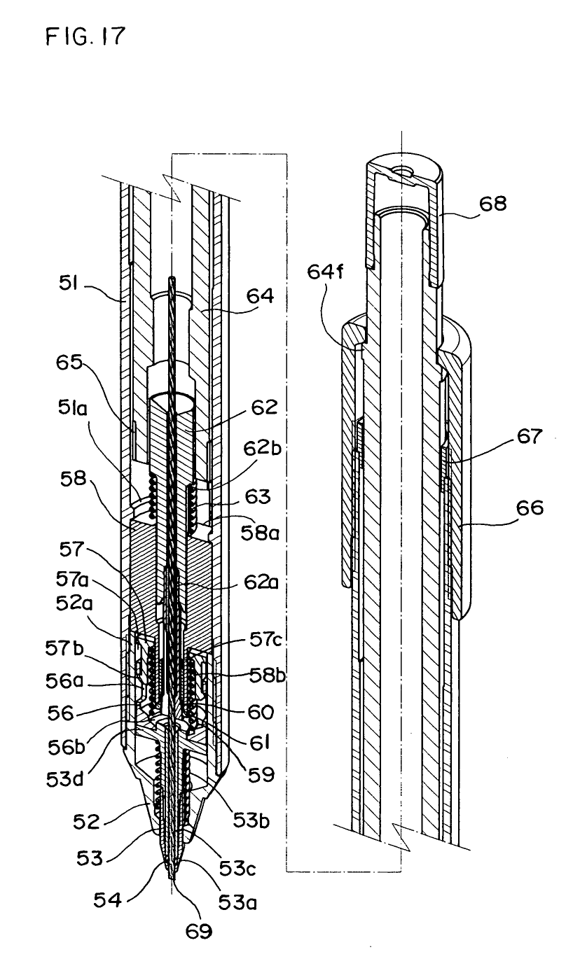

A second embodiment is explained with reference to the accompanying drawings. FIGS. 17 to 35 show a lead propelling device in the second embodiment of the invention.

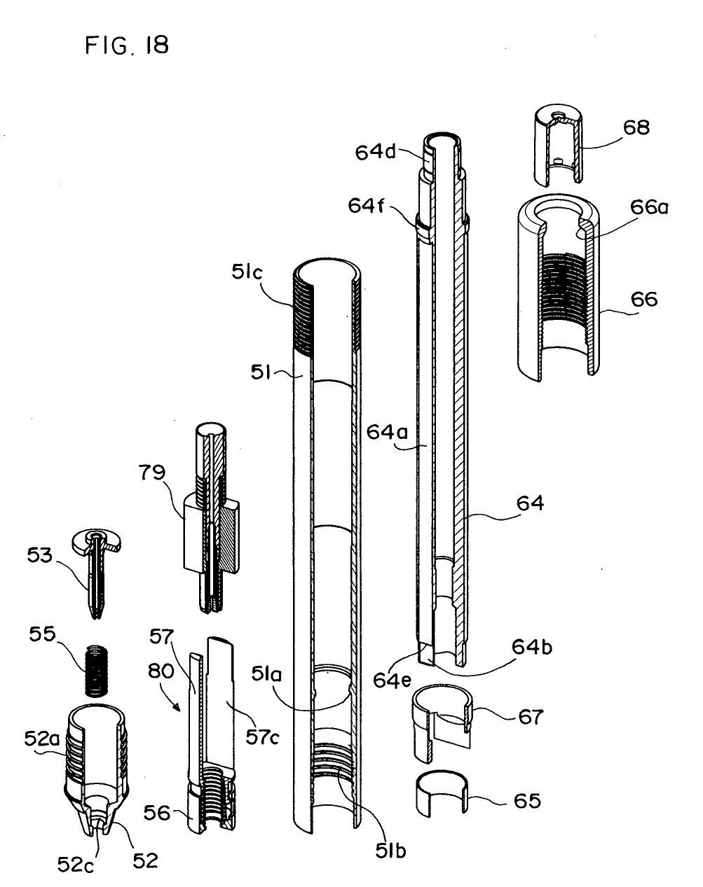

A mechanical pencil in the second embodiment comprises, as shown in FIGS. 17 and 18, a shaft tube 51, a tip 52, a slider 53, a lead gripping mechanism 79, a lead case 64, a knock cover 68, and other components and component units. In the second embodiment, first of all, the component units of the lead gripping mechanism 79, link unit 80, and slider 53 are explained below.

The lead gripping mechanism 79 is explained with reference to FIGS. 17, 18, 19, and 20.

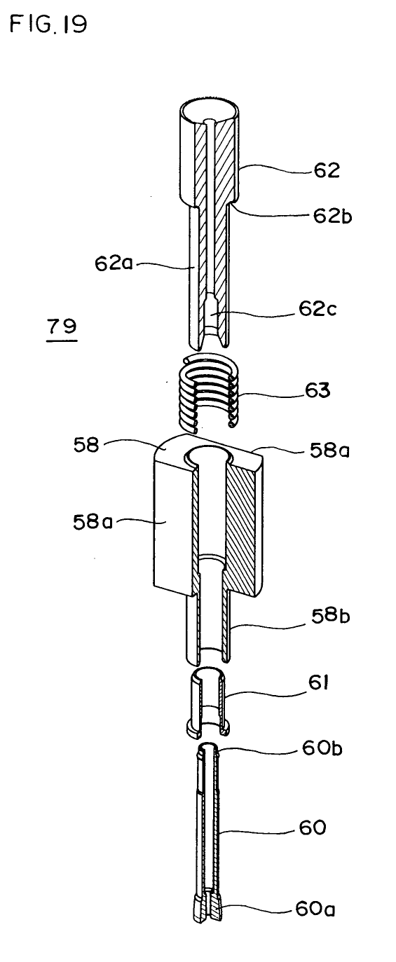

As shown in FIG. 19, a fixing tube 58 has a guide surface 58a of cylindrical shape of which both sides are cropped flatly, and a fine end tube 58b is formed at the front end. A tightening ring 61 is press-fitted and fixed as tightening part in the inner hole of the end tube 58b.

The tightening ring 61 is made of thin metal tubular body in a design to form a slender writing tool on the whole, but it is not always required in the structure of the invention, and it may be integrally formed as tightening part in the inner hole of the end tube 58b.

The chuck 60 is same as a chuck used generally in a mechanical pencil, and two-division or three-division slits are formed in the outer circumference of the gripping part 60a, and it is formed freely to expand and contract, and a convex engaging portion 60b is formed at the rear end of the chuck 60.

The gripping mechanism 79 is composed as follows. A chuck spring 63 is fitted to a shaft 62a of a chuck joint 62, the rear end of the chuck spring 63 is abutted against the step 62b, and the front end abuts against the rear end of the fixing tube 58. In this state, by inserting the chuck 60 into the tightening ring 61, and the chuck 60 is inserted from the front end of the fixing tube 58.

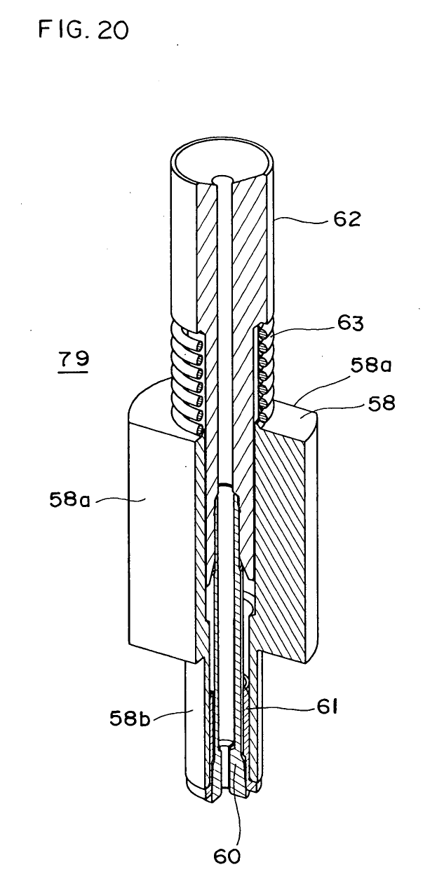

By press-fitting and engaging the engaging portion 60b of the chuck 60 into a engaging hole 62c provided at the front end of the shaft 62a of the chuck joint 62, the lead gripping mechanism 79 shown in FIG. 20 is composed.

The link unit 80 is explained with reference to FIGS. 17, 18, 21, and 22.

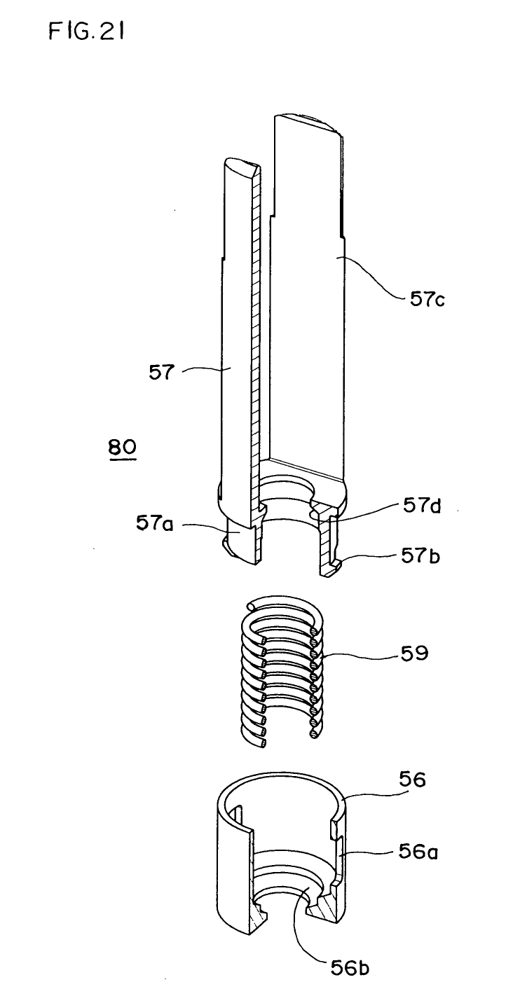

The link unit 80 is composed of link 57, link spring 59, and link joint 56 as shown in FIG. 21.

The link 57 has legs 57c flat at the inner side and extended long backward, formed at two positions along the outer periphery of the rear end of a tubular part 57a. An inner step 57d is provided at the inner hole rear end of the tubular part 57a, and hook-shaped engaging portions 57b are formed at two leading end positions of the tubular part 57a.

The link joint 56 is a tubular body, and slits 56a are opened at two side positions, and an inner step 56b is provided at the front end.

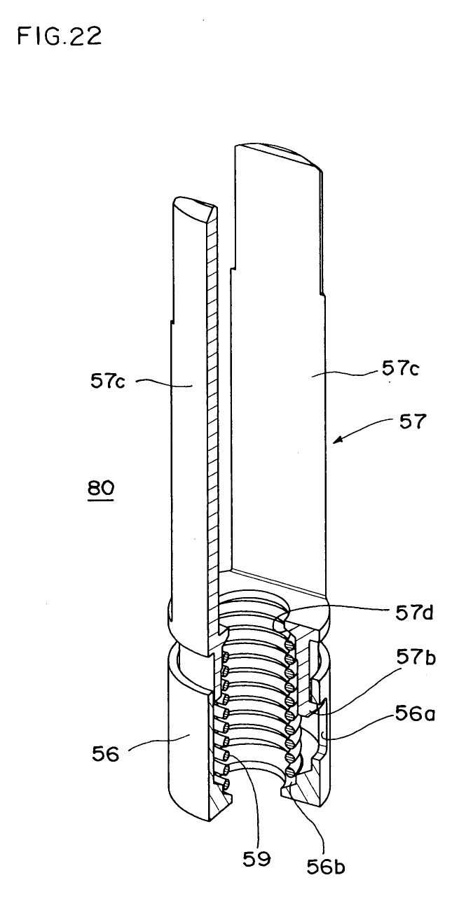

The front end of the link spring 59 abuts against the inner step 56b of the link joint 56, and the rear end abuts against the inner step 57d of the link 57, and in this state the engaging portion 57b is elastically fitted and engaged in the slit 56a. As a result, the link unit 80 shown in FIG. 22 is composed.

The slider 53 is explained with reference to FIGS. 17, 18, 23, and 24.

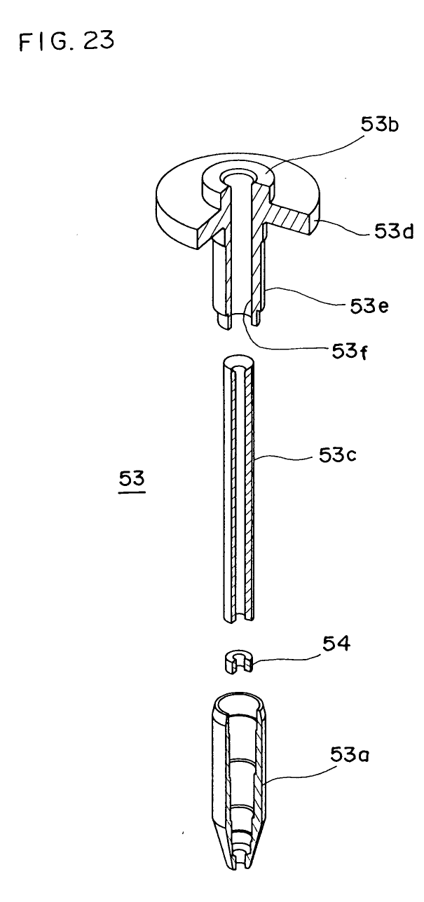

This slider 53 is composed of, as shown in FIG. 23, a rear member 53b, a guide pipe 53c, a stopper 54, and a tip member 53a.

The slider 53 has the stopper 54 made of an elastic material provided nearly at the front end of the inner hole of the fine tip member 53a. To hold the rear end of the stopper 54, the front part of the guide pipe 53c is fixed in the inner hole of the tip member 53a.

On the other hand, the rear member 53b has a flange 53d formed at the rear end, and a shaft 53e is integrally formed ahead. The rear part of the guide pipe 53c is inserted and fixed in the hole 53f of the shaft 53e of the rear member 53b.

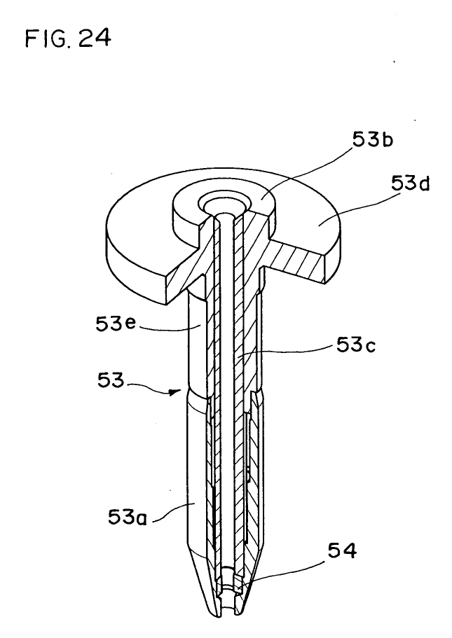

Further, the front end of the rear member 53b is inserted and fixed in the rear end hole of the tip member 53a, and the slider 53 as shown in FIG. 24 is formed.

The slider 53 allows the lead to be passed by way of the inner hole of the guide pipe 53c and inner hole of the stopper 54, but below a predetermined pressure, the leading end of the lead abuts against the rear end of the stopper 54, and it is composed so that the lead may not pass through. This stopper 54 is made of an elastically dislocating material such as rubber.

The entire structure of the invention is described with reference to FIGS. 17, 18, 25, and 26.

In the lead propelling device in the second embodiment, as shown in FIG. 18, a circular protrusion or circular step 51a is formed in the front inner wall of the inner hole of the shaft tube 51.

The lead gripping mechanism 79 is inserted from the front side of the shaft tube 51, and the rear end of the fixing tube 58 is abutted and fixed to the front part of the step 51a. In succession, the link unit 80 is inserted from the front end of the shaft tube 51. At this time, the inner side of the leg 57c of the link 57 is inserted oppositely to the flat guide surface 58a of the fixing tube 58.

The lead case 64 is a long tubular body as shown in FIG. 18, having a shaft 64d for detachably fixing the knock cover 68 at its rear end, and a flange 64f is formed slightly ahead. Flat parts 64a are formed at two positions approximately from the front end to near the front end of the tubular body along the periphery, and a further short flat part 64b is formed across a step 64e.

In the inner hole wall of a rotation stopping ring 67, flat parts are formed at two opposite positions. The rotation stopping ring 67 is fitted from at a front portion of the lead case 64, and the flat part of the rotation stopping ring 67 is fitted oppositely to the flat part 64a of the lead case 64. As a result, the rotation stopping ring 67 and the lead case 64 are integral in the rotating direction, and are not deviated in position.

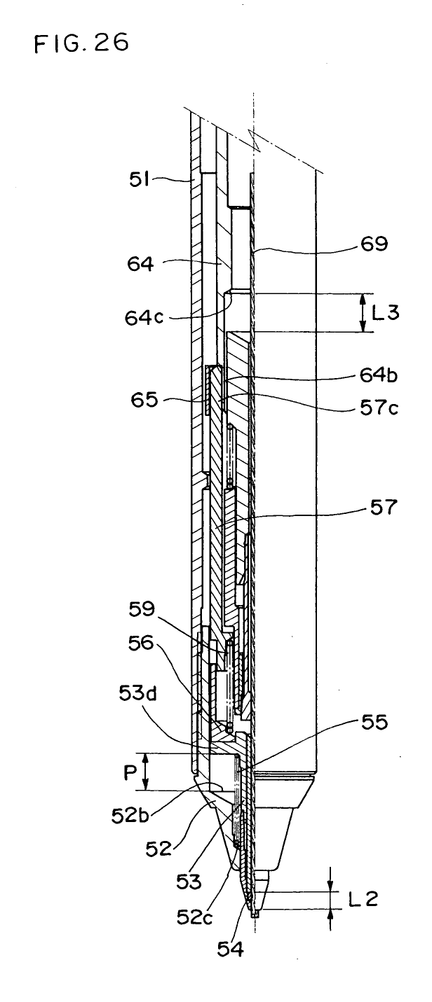

Further, as shown in FIG. 26, the inner side of the rear end of the leg 57c of the link 57 contacts with the flat part 64b of the lead case 64. The rear end outer periphery of the leg 57c is press-fitted and in contact with the inner side of the fixing ring 65. As a result, the link 57 and lead case 64 are fixed integrally.

At the front side of the flange 53d of the slider 53, a spring 55 is fitted with its rear end abutting against, and the front end of the spring 55 is abutted against the step 52c provided in the inner hole of the tip 52.

The slider 53 is inserted into the inner hole of the tip 52, and a threaded part 52a of the tip 52 is engaged with a threaded part 51b of the shaft tube 51, and a fixing tube 58 is fixed between the rear end of the tip 52 and the step 51a of the shaft tube 51.

At this time, the rear end of the flange 53d of the slider 53 is abutted against the front end of the link joint 56. As shown in FIG. 17, the front part of the rotation stopping ring 67 is fixed in the rear end hole of the shaft tube 51, and the lead case 64 is prevented from rotating in the rotating direction of the shaft tube 51.

In a threaded part 51c of the rear end outer periphery of the shaft tube 51, a crown 66 is engaged and fitted. At this time, by the spring 55, the flange 64f of the lead case 64 is pressed into the inner step 66a at the rear end of the crown 66.

The fixing tube 58 has a guide surface 58a having both sides of cylindrical shape cropped flatly, and the inner side of the leg 57c of the link 57 is inserted oppositely to the flat guide surface 58a of the fixing tube 58 so as to guide the leg 57c, but this guide format may be changed or modified depending on the design. In this embodiment, the separate members of the fixing tube 58 and shaft tube 51 are fixed, and formed integrally, but this fixing tube 58 may be also formed integrally with the shaft tube 51.

The lead case 64 has flat parts 64a formed at two positions along the periphery nearly from the front end of the flange 64f closely to the front end of the tubular body, and the rotation stopping ring 67 is mounted on the flat part 64a. This is, however, not always essential, and it is provided for preventing deformation or breakage of the leg 57c of the link 57 due to twisting in case of distortion of the lead case 64 by force in the rotating direction. Accordingly, anything may be used as far as deformation or breakage can be prevented, and the mode of the rotation stopping means may be changed in various modes depending on the design. Further, if the lead case 64 can be directly prevented from rotating on the shaft tube 51, the rotation stopping ring 67 may be omitted.

As mentioned above, the crown 66 is screwed and fitted into the rear end outer periphery of the shaft tube 51. Therefore, by engaging with the crown 66 and rotating and moving the crown 66 on the shaft tube 51, the lead case 64 can be moved forward and backward. By such move of the lead case 64, the slider 53 can be moved. As a result, as shown in FIG. 26, the interval P between the front side of the flange 53d of the slider 53 and the inner step of the tip 52 can be expanded or contracted. That is, rotation or moving of the crown 66 on the shaft tube 51 is a kind of an adjusting device of the interval P.

Such adjusting device is generally a screwed structure of shaft tube 51 and crown 66, but the mechanism is not limited to this structure alone. Further, a lock mechanism may be provided so as not to deviate the adjustment position, or a display device may be provided so that the level of adjustment may be known.

Meanwhile, the crown 66 may be fixed in a state of setting the interval P at an appropriate value.

The lead propelling device of the embodiment is thus configured, but is not particularly specified in the format of the component units and components. For example, the slider 53 is composed of multiple components, but it can be also made of a single element in an extreme case. The rear member 53b of the slider and the link joint 56 may be formed as one part.

In the embodiment, a link spring 59 is placed between the inner steps of the link joint 56 and link 57, and when a pressure is applied to the link joint 56 by more than a predetermined strength for the link 57, there is an action part for allowing the link 57 to advance on the link joint 56. But by forming the link joint 56 and link 57, a similar action part may be provided between the link rear part and front part of the lead case. Anyway, an optimum mode may be selected depending on the design.

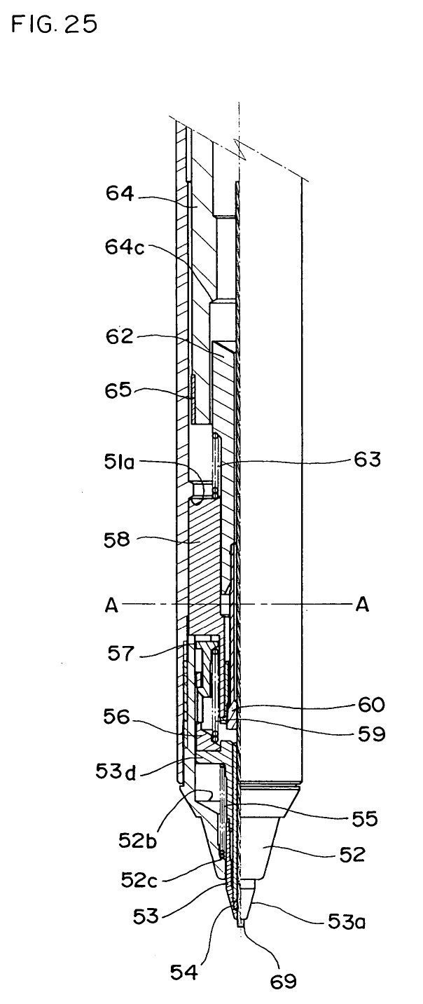

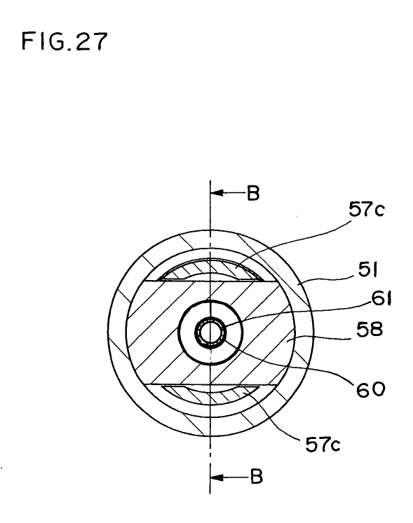

Then, referring to FIGS. 25 to 35, the operation of the lead propelling device in the second embodiment is described. FIG. 25 shows an initial state of operation of the leading end of the lead 69 projecting slightly to the leading end of the tip 53a of the slider. FIG. 27 is a section A-A view of FIGS. 25, and 26 is a sectional view corresponding to FIG. 25 in the section B-B direction of FIG. 27. That is, FIGS. 25 and 26 show sections deviated by 90° from each other.

First, as shown in FIG. 26, in this lead propelling device, the interval of the front side of the flange 53d of the slider 53 and the inner step 52b behind the tip 52 is set at P, the interval of the rear end of the stopper 54 and the front end of the end member 53a is set at L2, and the interval of the inner step 64c formed in the front inner hole of the lead case 64 and the rear end of the chuck joint 62 is set at L3.

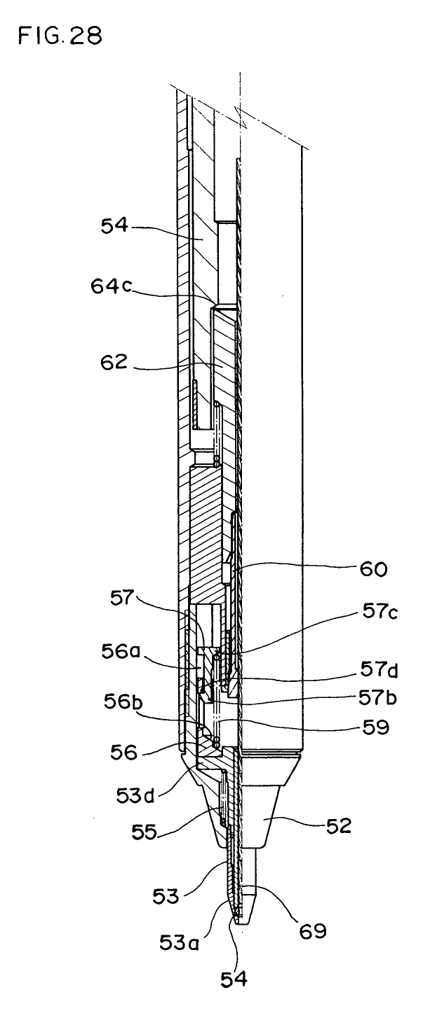

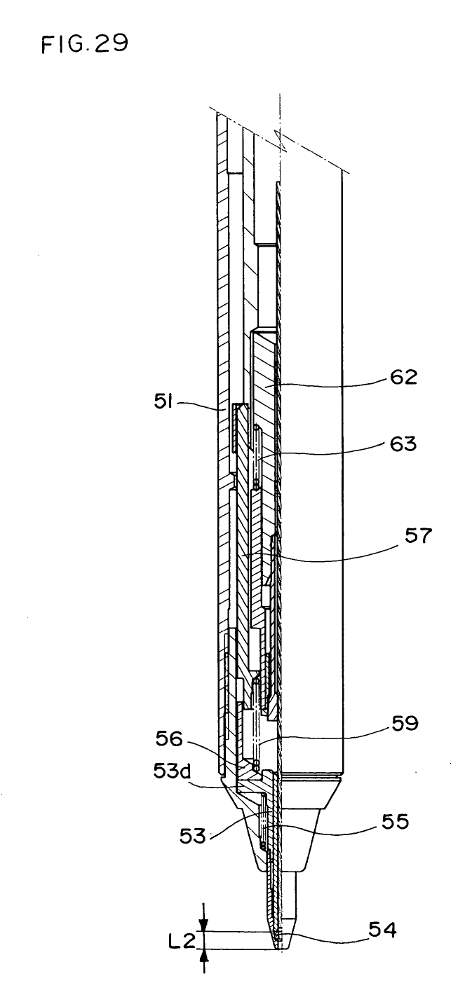

In the state shown in FIGS. 25 and 26, by knocking the knock cover 68, the lead case 64 is advanced, and the spring 55 is compressed by way of the link unit 80, and the slider 53 is moved forward. As a result, as shown in FIGS. 28 and 29, the front side of the flange 53d of the slider 53 abuts against the inner step 52b behind the tip 52. FIG. 29 similarly shows a sectional view deviated by 90° from the section shown in FIG. 28.

In FIGS. 28 and 29, the link spring 59 placed between the inner step 56b of the link joint 56 and the inner step 57c of the link 57 is not compressed, and the engaging portion 57b of the link 57 keeps a state engaged at the rear end of the slit 56a of the link joint 56.

That is, the link spring 59 is set in a sufficient strength for the spring 55 placed between the front side of the flange 53d of the slider 53 and the inner step at a front portion of the tip 52. The inner step 64c formed in the forward inner hole of the lead case 64 advances, but does not abut against the rear end of the chuck joint 62. At this time, since the lead 69 is gripped by the chuck 60, as the slider 53 advances, the leading end of the lead passes through the insertion hole of the stopper 54.

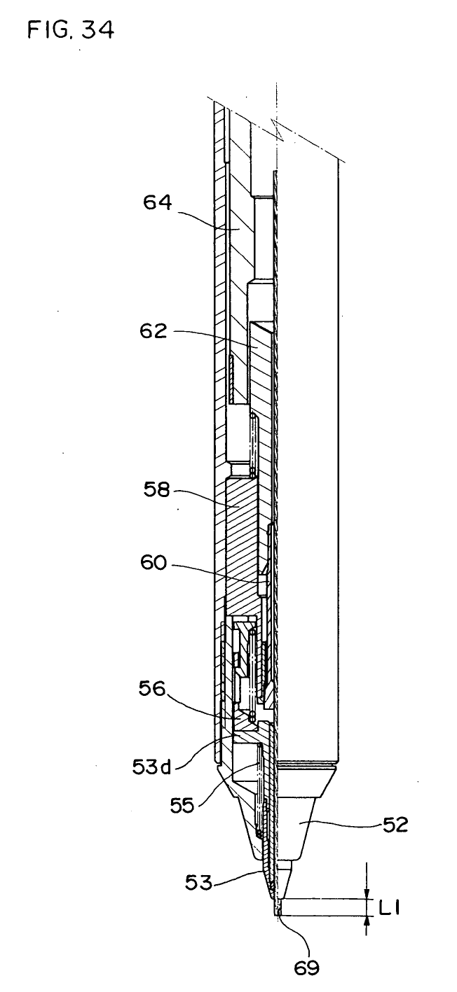

That is, the relation is L1=P−L2, where L1 is the projection length of the lead from the end member 53a described below (see FIG. 34).

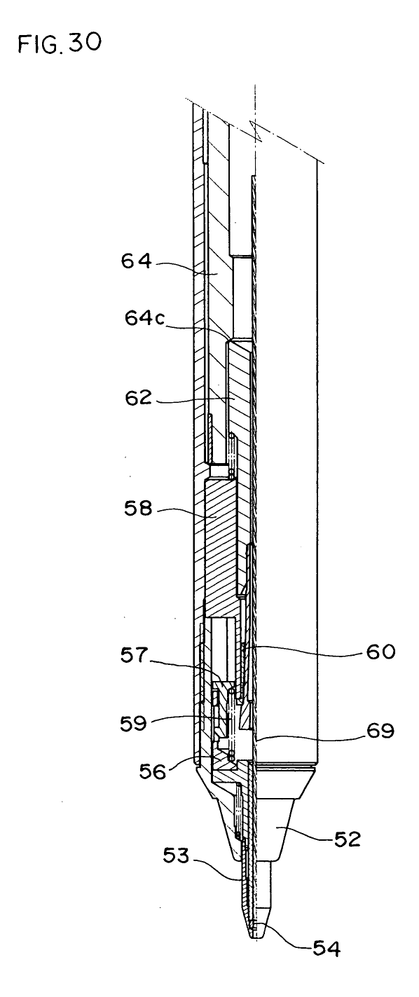

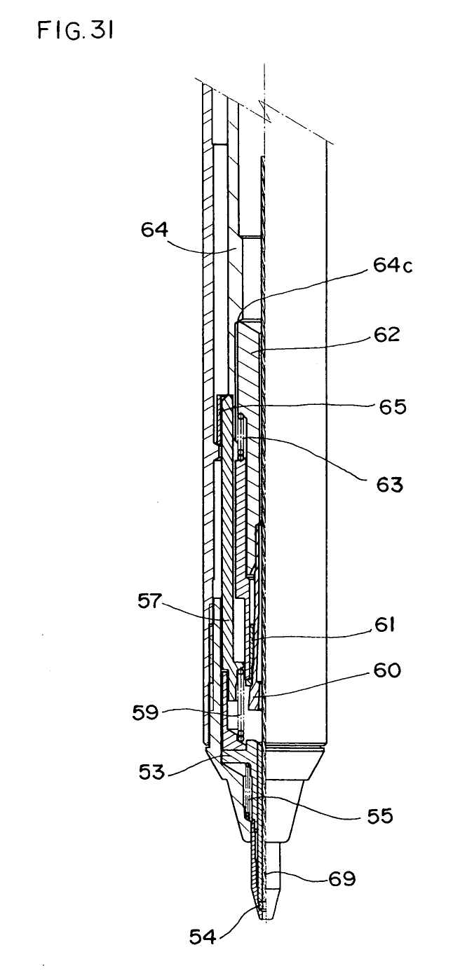

Further, as shown in FIGS. 30 and 31, while the forward move of the slider 53 is blocked, by knocking operation, when the lead case 64 advances further, the link 57 advances while compressing the link spring 59. FIG. 31 similarly shows a sectional view deviated by 900 from the section shown in FIG. 30.

The inner step 64c formed in the forward inner hole of the lead case 64 is also advanced, and abuts against the rear end of the chuck joint 62, and the chuck 60 is moved forward by way of the chuck joint 62, thereby releasing gripping of the lead 69.

When gripping of the lead 69 is released, the lead 69 falls by its own weight, and the leading end of the lead 69 abuts against the rear end of the stopper 54. The predetermined pressing force applied on the stopper 54 is at least the abutting force by the own weight of the lead applied on the stopper.

In this state, when knocking operation is cleared and the lead case 64 is moved back, while the slider 53 is held at the foremost position, the link 57 and chuck joint 622 move backward, and the lead 69 is gripped again. In this state, the engaging portion 57b of the link 57 is engaged at the rear end of the slit 56a of the link joint 56, and from this moment the link joint 56 is allowed to move backward. At the same time, by the restoring force of the spring 55, the slider 53 is ready to retreat.

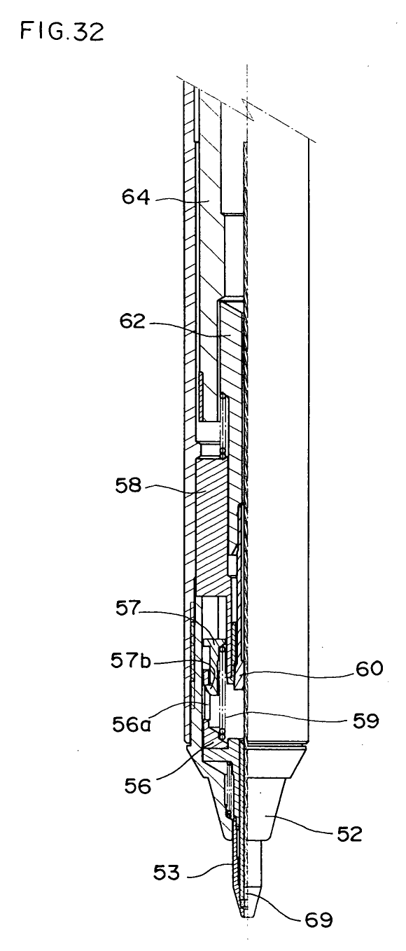

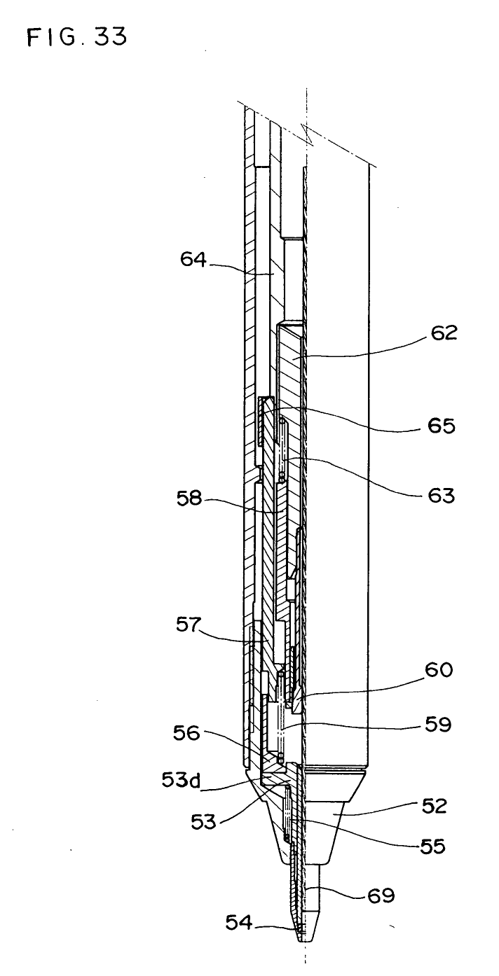

This state is shown in FIG. 32. FIG. 33 similarly shows a sectional view deviated by 90° from the section shown in FIG. 32.

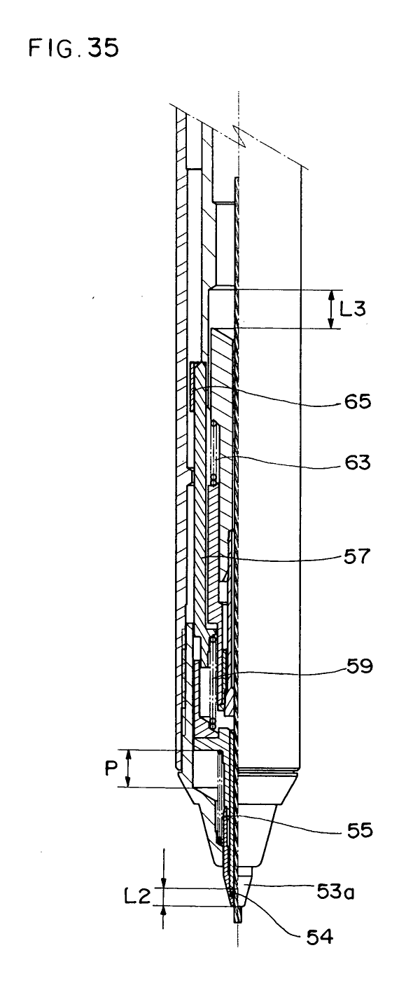

As shown in FIGS. 34 and 35, when the lead case 64 retreats to the initial state, the interval of the front side of the flange 53d of the slider 53 and the inner step behind the tip 52 becomes P again. FIGS. 34 and 35 are sectional views deviated by 90° from each other.

At this time, since the biasing force of the spring 55 is set sufficiently stronger than the resistance of the lead 69 passing through the stopper 54, the leading end of the lead 69 passes through the stopper 54, and projects from the front end of the end member 53a by a proper length. The projection length L1 is defined as L1=P−L2 as mentioned above.

Incidentally, it is a demerit that the dimension of L3 may have a significantly large fluctuation in spite of a slight fluctuation of lead diameter. Therefore, in an extreme case, the dimension of L3 differs in every lead being sent into the chuck.

However, in the second embodiment, by setting at P<L3, the lead projection length L1 is defined by P−L2, and is indifferent to the above fluctuations.

In this state, if knocked again, the lead case 64 moves by distance L3, and the stopper 54 passes through at a front portion of the lead 69 as shown in FIGS. 28 and 29. After the state as shown in FIG. 30 (FIG. 31) and FIG. 32 (FIG. 33), the state as shown in FIG. 34 (FIG. 35) is established.

In this manner, even if the knocking operation is repeated, by repeating the operation as shown in FIGS. 28 to 35, the lead 69 is not projected more than a specified extent from the slider 53. If the lead 69 is worn out by writing, by this operation, the lead can be projected from the slider 53 only by the predetermined projection length.

As for the lead projection length L1, the optimum value differs depending on the lead diameter and lead hardness. Therefore, an adjusting mechanism is provided for adjusting the dimension of the interval P for obtaining an optimum lead projection length. As one of such means, by engagement of the crown 66 with the rear end outer periphery of the shaft tube 51, the crown 66 is rotated on the shaft tube 51, and the slider 53 is moved back and forth by way of the lead case 64 and link unit, so that the interval P is adjusted.

In the lead propelling device of the invention, as described herein, the lead is projected by a predetermined length from the leading end of the writing tool by knocking operation, and the lead is maintained at the predetermined length if the knocking operation is repeated, and hence it is free from problems such as breakage of lead or excessive projection of lead by knocking unknowingly while writing, and further the tip can be recognized visually and easily, it is easy to use, and if the lead is fine, the lead is not broken or damaged (so-called biting of lead or roughening of lead surface) by the gripping part of the chuck, so that outstanding effects may be obtained.

What is claimed is:

1. A lead propelling device characterized by a structure for gripping and releasing the lead by a lead gripping mechanism by knocking operation, not transmitting the knocking force to the lead gripping mechanism in knock forward operation, having a stopper not allowing the lead to pass by the own weight of the lead interlocking with the knock operation, with the lead abutting against the stopper rear end when the lead gripping mechanism releases the lead, and having the lead inserted into the stopper after the lead gripping mechanism grips the lead in knock backward operation, thereby propelling the lead,
wherein the knock operation part advances by a predetermined distance, and then the lead gripping mechanism releases gripping of the lead, and further when the lead gripping mechanism grips the lead in the backward stroke of the knock operation part, the knock operation part is set to be movable backward further by a predetermined distance.

2. A lead propelling device for releasing the lead by a lead gripping mechanism by knock operation and gripping the lead by the lead gripping mechanism when the knock operation is canceled,
wherein a slider is provided so as to project movably forward and backward from the leading end hole at the tip of the leading end of a shaft tube, an elastically dislocating stopper is fixed in the inner hole of the slider for allowing the lead to pass and blocking insertion of the lead by abutting against the leading end of the lead equal to or below a predetermined pressing force, the slider is biased backward by a spring so as to interlock with a lead case,
a lead gripping mechanism is provided behind the slider, the lead gripping mechanism is composed so as to grip or release the lead by departing or abutting between a step of the rear part of the lead gripping mechanism and a step of the lead case,
the lead gripping mechanism holds the lead until the knock operation part advances by a predetermined distance, maintaining a fixed state, the slider advances in conjunction with the lead case, and the leading end of the lead is departed from the rear end of the stopper by a predetermined distance,
when the knock operation part is further advanced from the predetermined distance, the slider and chuck advance in conjunction with the lead case, and the lead gripping mechanism releases gripping of the lead, the lead abuts against the stopper rear end by spontaneous fall of the lead, and
when the knock operation part moves backward by releasing the knock operation, the slider and chuck retreat, and when the lead gripping mechanism grips the lead, only the slider moves backward to the initial position and the lead passes through the stopper, so that the lead is projected from the leading end of the slider by a predetermined length.

3. The lead propelling device of claim 1 or 2, wherein the lead gripping mechanism comprises a cylindrical fixing tube, a tightening member fixed to the leading end of an inner hole provided in the fixing tube, a chuck for gripping and releasing the lead by the tightening member, a chuck joint fixed to the rear end of the chuck, and a chuck spring disposed between the rear end face of the fixing tube and chuck joint for biasing the chuck backward.

4. The lead propelling device of claim 1 or 2, wherein the stopper has a hard part located at the abutting position of the leading end of the lead, and an elastic part is provided on the contour of the hard part so that the lead can pass through with a predetermined pressing force applied to the leading end of the lead.

5. The lead propelling device of claim 1 or 2, wherein the lead gripping mechanism is fixed to a cylindrical shaft tube, a notch is provided at the side of the fixed tube or in the inner wall of the shaft tube so as to allow a space between the fixed tube and shaft tube inner wall,
a leg is provided at a front portion of the lead case so as to be movable forward and backward in the space, the front end of the leg and the rear end of the slider abut against each other so as to interlock, and
a step is provided in the inner hole of the lead case as an operating part for expanding the lead gripping mechanism, and abuts against the chuck joint as an operating part of the lead gripping mechanism, thereby expanding the lead gripping mechanism.

6. The lead propelling device of claim 2, wherein a leg is provided at a rear portion of the slider, the rear end face of the leg and the front end face of the lead case abut against each other so as to interlock, and
a step is provided in the inner hole of the lead case as an operating part for expanding the lead gripping mechanism, and abuts against the chuck joint as an operating part of the lead gripping mechanism, thereby expanding the lead gripping mechanism.

7. The lead propelling device of claim 2, wherein the slider and lead case are coupled and fixed, and the lead case is biased backward by the spring.

8. The lead propelling device of claim 3, wherein the fixed tube is formed integrally with the shaft tube.

9. The lead propelling device of claim 3, wherein the tightening member is formed integrally with the fixed tube.

10. The lead propelling device of claim 2, wherein the predetermined length L1 of the lead projecting from the front end of the slider, the distance L2 from the slider front end to the stopper rear end, and the distance L3 between a step provided in the rear part of the lead gripping mechanism and a step of the lead case in the state of gripping the lead by the lead gripping mechanism are in the relation of L1=L3−L2.

11. The lead propelling device of claim 2, wherein the pressing force P1 by which the lead can pass through the stopper and the initial tension P2 of the spring are set in the relation of P1 <P2.

12. A lead propelling device for releasing the lead by a lead gripping mechanism by knock operation and gripping the lead by the lead gripping mechanism when the knock operation is canceled,
wherein a slider is provided so as to project movably forward and backward from the leading end hole at the tip of the leading end of a shaft tube, an elastically dislocating stopper is fixed in the inner hole of the slider for allowing the lead to pass and blocking insertion of the lead by abutting against the leading end of the lead equal to or below a predetermined pressing force, the slider is biased backward by a spring so as to interlock with a lead case by way of a link unit,
a lead gripping mechanism is provided on a rear portion of the slider in a state of gripping the lead, and
the lead gripping mechanism maintains the lead gripping state when knock operation is started, the slider advances in conjunction with the lead case by way of the link unit, the lead is departed from the stopper rear end by a predetermined distance when the slider advances to the maximum and the advance is blocked, and when the knock operation further continues, the link unit contracts and the lead case advances, thereby releasing the lead by the lead gripping mechanism, the lead abuts against the stopper rear end by spontaneous fall of the lead, when knock operation is canceled, the lead gripping mechanism grips the lead while the slider maintains the foremost position, and the slider retreats to the initial position, and the lead passes through the stopper, so that the lead is projected from the leading end of the slider by a predetermined length.

13. The lead propelling device of claim 12, wherein the stopper has a hard part located at the abutting position of the leading end of the lead, and an elastic part is provided on the contour of the hard part so that the lead can be passed through a predetermined pressing force applied to the leading end of the lead.

14. The lead propelling device of claim 12, wherein the lead gripping mechanism has a structure of gripping and releasing the lead by abutment of a step in the rear part of the lead gripping mechanism and a step of the lead case, and
the timing of gripping or releasing the lead by the lead gripping mechanism is determined by the spatial distance between the step in the rear part of the lead gripping mechanism and the step of the lead case.

15. The lead propelling device of claim 12, wherein the link unit comprises a link joint, a link having its front end coupled at the rear portion of the link joint, and a link spring placed between an inner step of the link joint and an inner step of the link, and the link is always biased backward of the link joint by the link spring,
the front end of the link joint abuts against the rear end of the slider, and the link is fixed to the forward part of the lead case, and
the link unit interlocks with the lead case by knock operation to advance the slider, and the biasing force of the link spring is set so that the link may advance to the link joint from the state of blocking the advance at the foremost position of the slider.

16. The lead propelling device of claim 12, wherein the lead gripping mechanism comprises a cylindrical fixing tube, a tightening member fixed to the leading end of an inner hole provided in the fixing tube, a chuck for gripping and releasing the lead by the tightening member, a chuck joint fixed to the rear end of the chuck, and a chuck spring disposed between the rear end face of the fixing tube and chuck joint for biasing the chuck backward, and the lead gripping mechanism is fixed to a cylindrical shaft tube, a notch is provided at the side of the fixing tube or in the inner wall of the shaft tube so as to allow a space between the fixing tube and shaft tube inner wall,
the slider and lead case interlock by means of a link unit through which a leg provided in the rear part of the link passes so as to be movable forward and backward in the space, and
a step is provided in the inner hole of the lead case as an operating part for expanding the lead gripping mechanism, and abuts against the chuck joint as an operating part of the lead gripping mechanism, thereby expanding the lead gripping mechanism.

17. The lead propelling device of claim 12, wherein the predetermined length L1 of the lead projecting from the front end of the slider, the distance L2 from the slider front end to the stopper rear end, and the distance P between the front end of flange of the slider and the inner step of the tip are in the relation of L1=P−L2.

18. The lead propelling device of claim 15, wherein the pressing force P1 by which the lead can pass through the stopper, the initial tension P2 of the spring, and the initial tension P3 of the link spring are set in the relation of P1<P2, P2 <P3.

19. The lead propelling device of claim 16, wherein the fixing tube is formed integrally with the shaft tube.

20. The lead propelling device of claim 16, wherein the tightening member is formed integrally with the fixing tube.
